(19) United States
(12) Patent Application Publication
(10) Pub. No.: US 2026/0184196 A1
(43) Pub. Date: Jul. 2, 2026

(54) METHOD FOR CONTROLLING VEHICLE AND VEHICLE IMPLEMENTING THE SAME

(71) Applicants: HYUNDAI MOTOR COMPANY, SEOUL (KR); KIA CORPORATION, SEOUL (KR)

(72) Inventors: Sang Hyun Jeong, Hwaseong-si (KR); Jung Un An, Hwaseong-si (KR)

(73) Assignees: HYUNDAI MOTOR COMPANY, SEOUL (KR); KIA CORPORATION, SEOUL (KR)

(21) Appl. No.: 19/308,642

(22) Filed: Aug. 25, 2025

(30) Foreign Application Priority Data
Jan. 2, 2025 (KR) 10-2025-0000274

(51) Int. Cl. B60L 50/40; B60L 7/16; B60L 50/60

(52) U.S. Cl. CPC B60L 50/40; B60L 7/16; B60L 50/60; B60L 2240/423; B60L 2240/545; B60L 2240/662

(57) ABSTRACT

The present disclosure provides a vehicle. The vehicle includes a drive motor, a battery configured to discharge power to be supplied to the drive motor or charge power generated by regenerative braking of the drive motor, a supercapacitor configured to discharge power to be supplied to the drive motor or charge power generated by regenerative braking of the drive motor, and a controller. The controller includes a memory configured to store computer-readable instructions and at least one processor configured to execute the instructions. The at least one processor performs the instructions, and the controller performs a virtual gear shift mode by using the supercapacitor according to a torque map that is set based on a chargeable or dischargeable state of the battery or a temperature outside the battery or the vehicle.

### CROSS-REFERENCE TO RELATED APPLICATION(S)

The present application claims priority to Korean Patent Application No. 10-2025-0000274, filed on January 2, 2025, the entire contents of which is incorporated herein for all purposes by this reference.

### TECHNICAL FIELD

The present disclosure relates to a method for controlling a vehicle and a vehicle implementing the same.

### BACKGROUND

A gasoline vehicle has a transmission that is generally controlled according to a set gear shift map, and a driver feels a sensation of gear shifting for each gear shift.

Although an electric vehicle typically has a difficulty in providing the sensation of gear shifting of the gasoline vehicle, U.S. Patent No. US11872890 proposes a control method for generating a virtual sensation of gear shifting of an electric vehicle to satisfy drivers who seek the sensation of gear shifting in the electric vehicle.

### SUMMARY

The present disclosure provides a virtual gear shift when charging or discharging a battery is restricted or in a (e.g., specific) temperature condition, and further is intended to address limitations of the prior art.

The present disclosure also provides a method for dualizing a power supply source for a drive motor to improve energy efficiency, thereby improving durability of a battery and fuel efficiency.

An example embodiment of the present disclosure provides a vehicle including a drive motor, a battery configured to discharge first power to supply to the drive motor or to be charged by second power generated by regenerative braking of the drive motor, a supercapacitor configured to discharge third power to supply to the drive motor or to be charged by the second power, and a controller including a memory storing computer-readable instructions and at least one processor configured to execute the computer-readable instructions. When executed by the at least one processor, the computer-readable instructions cause the controller to perform a virtual gear shift mode using the supercapacitor based on a torque map, which is determined based on a chargeable and/or dischargeable state of the battery or a temperature of the battery or an external temperature around the vehicle.

In an example embodiment, the computer-readable instructions may cause the controller to perform the virtual gear shift mode based on a first torque map or a second torque map determined based on the temperature when the battery is in a chargeable and dischargeable state

In an example embodiment, the computer-readable instructions may cause the controller to perform the virtual gear shift mode based on the first torque map when the temperature is lower than a first preset temperature and to perform the virtual gear shift mode based on the second torque map when the temperature is greater than a second preset temperature.

In an example embodiment, the computer-readable instructions may cause the controller to perform the virtual gear shift mode based on a third torque map or a fourth torque map determined based on the temperature when both charging and discharging of the battery are restricted.

In an example embodiment, the computer-readable instructions may cause the controller to perform the virtual gear shift mode based on the third torque map when the temperature is less (e.g., lower) than a first preset temperature and to perform the virtual gear shift mode based on the fourth torque map when the temperature is greater than a second preset temperature.

In an example embodiment, the computer-readable instructions may cause the controller to perform the virtual gear shift mode based on a fifth torque map or a sixth torque map determined based on the temperature when charging of the battery is restricted.

In an example embodiment, the computer-readable instructions may cause the controller to perform the virtual gear shift mode based on the fifth torque map when the temperature is lower than a first preset temperature and to perform the virtual gear shift mode based on the sixth torque map when the temperature is greater than a second preset temperature.

In an example embodiment, the computer-readable instructions may cause the controller to perform the virtual gear shift mode based on a seventh torque map or an eighth torque map determined based on the temperature when discharging of the battery is restricted.

In an example embodiment, the computer-readable instructions may cause the controller to perform the virtual gear shift mode based on the seventh torque map when the temperature is lower than a first preset temperature and to perform the virtual gear shift mode based on the eighth torque map when the temperature is greater than a second preset temperature.

In an example embodiment, the computer-readable instructions may cause the controller to perform the virtual gear shift mode based on a ninth torque map when the temperature is greater than or equal to a first preset temperature and lower than or equal to a second preset temperature.

In an example embodiment of the present disclosure, there is provided a method for controlling a vehicle. The vehicle includes a drive motor, a battery configured to discharge first power to supply to the drive motor or to be charged by second power generated by regenerative braking of the drive motor, a supercapacitor configured to discharge third power to supply to the drive motor or to be charged by the second power, and a controller including a memory storing computer-readable instructions and at least one processor configured to execute the computer-readable instructions. The method may include determining, by the controller, a chargeable state or a dischargeable state of the battery, and performing, by the controller, a virtual gear shift mode using the supercapacitor based on a torque map which is determined based on a temperature of the battery or around the vehicle.

In an example embodiment, the performing of the virtual gear shift mode may comprise performing the virtual gear shift mode based on a first torque map or a second torque map determined based on the temperature when the battery is in a chargeable and dischargeable state.

In an example embodiment, the performing of the virtual gear shift mode based on the first torque map or the second torque map may comprise performing the virtual gear shift mode based on the first torque map when the temperature is lower than a first preset temperature, and performing the virtual gear shift mode based on the second torque map when the temperature is greater than a second preset temperature.

In an example embodiment, the performing of the virtual gear shift mode may comprise performing the virtual gear shift mode based on a third torque map or a fourth torque map based on the temperature when both charging and discharging of the battery are restricted.

In an example embodiment, the performing of the virtual gear shift mode based on the third torque map or the fourth torque map may comprise performing the virtual gear shift mode based on the third torque map when the temperature is lower than a first preset temperature, and performing the virtual gear shift mode based on the fourth torque map when the temperature is greater than a second preset temperature.

In an example embodiment, the performing of the virtual gear shift mode may comprise performing the virtual gear shift mode based on a fifth torque map or a sixth torque map based on the temperature when charging of the battery is restricted.

In an example embodiment, the performing of the virtual gear shift mode based on the fifth torque map or the sixth torque map may comprise performing the virtual gear shift mode based on the fifth torque map when the temperature is lower than a first preset temperature, and performing the virtual gear shift mode based on the sixth torque map when the temperature is greater than a second preset temperature.

In an example embodiment, the performing of the virtual gear shift mode may comprise performing the virtual gear shift mode based on a seventh torque map or an eighth torque map based on the temperature when discharging of the battery is restricted.

In an example embodiment, the performing of the virtual gear shift mode based on the seventh torque map or the eighth torque map may comprise performing the virtual gear shift mode based on the seventh torque map when the temperature is lower than a first preset temperature, and performing the virtual gear shift mode based on the eighth torque map when the temperature is greater than a second preset temperatur.

In an example embodiment, the performing of the virtual gear shift mode may comprise performing the virtual gear shift mode using the battery according to a ninth torque map when the temperature is greater than or equal to a first preset temperature and lower than or equal to a second preset temperature.

### BRIEF DESCRIPTION OF THE DRAWINGS

FIG. 1 is a diagram illustrating a configuration of a vehicle according to an example embodiment of the present disclosure.

FIG. 2 is a table showing characteristics of a battery and a supercapacitor according to an example embodiment of the present disclosure.

FIGS. 3A, 3B, and 3C are flowcharts representing a control method according to an example embodiment of the present disclosure.

FIG. 4 is a view illustrating a torque map for the supercapacitor.

FIGS. 5A and 5B illustrate respectively discharge characteristics and a torque map of a battery according to a temperature of the battery.

FIGS. 6A and 6B illustrate respectively discharge characteristics and a torque map of a supercapacitor according to a temperature of the supercapacitor.

FIG. 7 is a graph of a result of virtual gear shift control according to an example embodiment of the present disclosure.

### DETAILED DESCRIPTION

Since the present disclosure may have various embodiments, example embodiments are illustrated in the drawings and are described in the detailed description of the disclosure. However, the example embodiments do not limit the present disclosure to specific embodiments, and the present disclosure is intended to cover modifications, equivalents, and replacements within the scope of the present disclosure.

In this specification, the suffixes "module" and "unit" are used for nominal distinction between components and should not be interpreted as implying that the components are physically or chemically separated or that they can be separated.

Although the terms of “first” and “second” are used herein to describe various elements, these elements should not be limited by these terms. These terms may be used to differentiate one component from another in name, and their sequential meanings provide context to the description rather than by the names themselves.

The term "and/or" is used to include possible combinations of the listed items. For example, "A and/or B" includes (e.g., all) three cases of "A", "B", and "A and B".

When an element is referred to as “connected to” or “engaged with” another element, it can be directly connected to the other element, or intervening elements may also be present.

In the following description, the technical terms are used for explaining an example embodiment while not limiting the present disclosure. The terms of a singular form may include plural forms unless referred to the contrary. The meaning of “include” or “comprise” may specify a property, a region, a fixed number, a step, a process, an element and/or a component and may not exclude other properties, regions, fixed numbers, steps, processes, elements and/or components.

Unless terms used in the present disclosure are provided (e.g., defined) differently, the terms may be construed as those known to one skilled in the art. Terms such as terms that are generally used and have been in dictionaries may be construed as having meanings matched with contextual meanings. In this description, unless provided (e.g., defined), terms should not be ideally and/or excessively construed.

Also, the terms unit, control unit, control device, or controller are widely used to name devices that control specific functions and do not refer to a generic functional unit. Also, the devices denoted by the names may include a communication device that communicates with another controller or sensor to control the corresponding function, a computer-readable recording medium that stores an operation system, a logic command, and input/output information, and at least one processor that performs determinations, decisions, and calculations required for function control.

The processor may include semiconductor integrated circuits and/or electronic elements that perform at least one or more of comparisons, determinations, calculations, and decisions to achieve programmed functions.

For example, the processor may be a computer, a microprocessor, CPU, ASIC, an electronic circuitry (logic circuits), or a combination thereof.

Also, the computer readable recording medium (or memory) may include various data storage devices for storing computer readable data. For example, the computer readable recording medium may include at least one of a flash memory type, hard disk type, micro type, card type (e.g., secure digital (SD) card) or eXtream digital (XD) type memory and a random access memory (RAM), static RAM (SRAM), read-only memory (ROM), programmable ROM (PROM), electrically erasable PROM (EEPROM), magnetic RAM (MRAM), magnetic disk, or optical disk type memory. These recording media may be electrically connected to the processor, and the processor may read data from and write data to the recording media. The recording media and the processor may be integrated with each other or physically separated from each other.

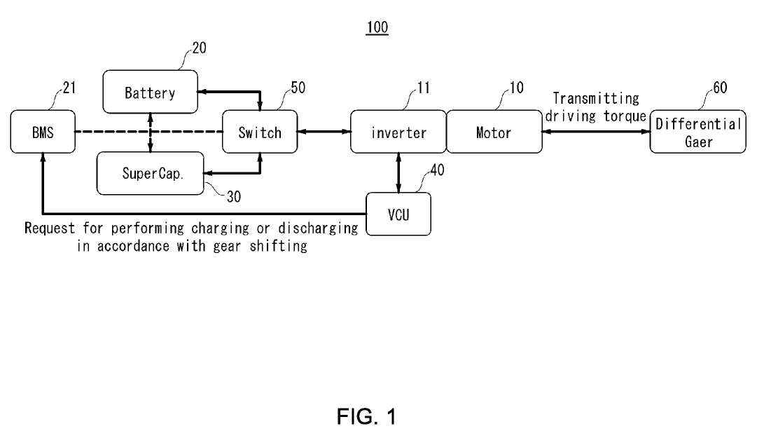

Referring to FIG. 1, a vehicle 100 according to an example embodiment includes a drive motor 10 capable of providing driving force to a wheel through a differential gear 60 or generating power during regenerative braking to charge a battery 20 or a supercapacitor 30. The battery 20 and the supercapacitor 30 may supply power to the drive motor 10. The vehicle also may include a controller 40 for controlling (e.g., all of) the above-described units.

The supercapacitor 30 that is a capacitor having an (e.g., extremely) large capacitance and may also be referred to as an ultra-capacitor or an ultrahigh capacity capacitor. Unlike the battery 20 using a chemical reaction, the supercapacitor 30 uses a charging phenomenon caused by a simple movement of ions toward an interface between an electrode and an electrolyte or a surface chemical reaction.

The supercapacitor 30 may have a basic structure including a porous electrode that constitutes a positive electrode and a negative electrode, an electrolyte, a current collector, and a separation membrane or separator. The supercapacitor 30 may operate based on an electrochemical mechanism occurring when ions in the electrolyte move along an electric field and are adsorbed to a surface of an electrode by applying a voltage to (e.g., both) ends of a unit cell electrode.

The supercapacitor 30 is charged and discharged while the ions of the electrolyte are adsorbed to and desorbed from the surface of the electrode or through a surface chemical reaction. A supercapacitor that is charged and discharged through the adsorption and desorption of ions is referred to as an electrical double layer capacitor (EDLC), and a supercapacitor that is charged and discharged through the surface chemical reaction is referred to as a pseudocapacitor. Also, there is a hybrid supercapacitor in which characteristics of the above-described supercapacitor are (e.g., appropriately) mixed by using an asymmetric electrode.

On the other hand, in an example embodiment, the battery 20 may be a lithium-ion battery 20. The lithium-ion battery 20 may be (e.g., a kind of) a secondary battery, in which lithium ions move from a negative electrode to a positive electrode during discharging and move back from the positive electrode to the negative electrode during charging.

The battery 20 (e.g., that is a so-called high-voltage battery) may include a plurality of battery cells (not shown). Each battery cell may output a voltage of, e.g., 2.7 V to 4.2 V. The battery 20 may include a predetermined number of the battery cells, and the battery cells may be connected in series or parallel to form a single module. The battery 20 may have a packaged shape as a single battery package in which one or more battery modules are connected in series or parallel to output, e.g., about 400 V, about 800 V, or several kV.

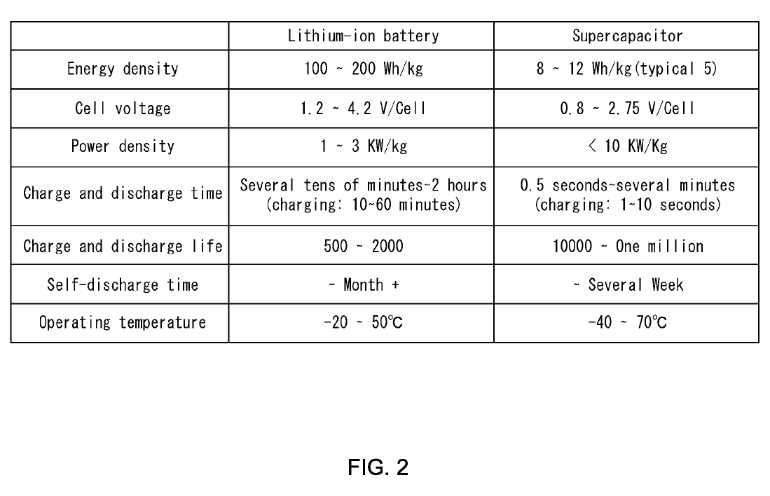

FIG. 2 is a table showing characteristics of the lithium-ion battery 20 and the supercapacitor 30 according to an example embodiment of the present disclosure.

As shown in FIG. 2, the battery 20 according to the example embodiment may have an energy density of 100 Wh/kg to 200 Wh/kg, a cell voltage of 1.2 V to 4.2 V, and a power density of 1 3 kW/kg to 3 kW/kg. The battery 20 may have a charge and discharge time of about (e.g., several) tens of minutes to about 2 hours, such as a charge time of about 10 minutes to about 60 minutes. Also, the battery 20 may have a charge and discharge life of 500 cycles to 2000 cycles, a self-discharge time of several months or more, and an operating temperature of -20°C to 50°C.

As shown in FIG. 2, the supercapacitor 30 may have an energy density of about 8 Wh/kg to 12 Wh/kg, a cell voltage of 0.8 V to 2.75 V, and a power density of up to 10 kW/kg. The supercapacitor 30 may have a charge and discharge time of about 0.5 seconds to several minutes, such as a charge time of about 1 second to about 10 seconds. Also, the supercapacitor 30 may have a charge and discharge life of 10,000 cycles to 1,000,000 cycles, a self-discharge time of several weeks, and an operating temperature of -40°C to 70°C.

The battery 20 has an energy density greater than that of the supercapacitor 30, is discharged at a stable voltage, and operates even at a higher operating voltage depending on an electrode material. On the other hand, the supercapacitor 30 has a high power density, a fast charge time, and an (e.g., extremely) high charge and discharge durability.

Also, the battery 20 has a power density and a cycle life less than those of the supercapacitor 30. The supercapacitor 30 has a lower energy density, a higher cost, a higher voltage variation over time during charging and discharging, and a higher self-discharge rate in comparison with the battery 20.

Although characteristics of the battery 20 and the supercapacitor 30 are provided with respect to an example embodiment in FIG. 2, the embodiment of the present disclosure is not limited thereto.

Referring back to FIG. 1, a battery management system (BMS) 21 may be communicatively connected to the controller 40 (e.g., VCU, a vehicle control unit) in a wired or wireless manner, and through this, various sensing information (e.g., voltage, current, and temperature) related to a state of charge (SoC) and physical, electrical, or chemical states of the battery 20 and/or the supercapacitor 30 is transmitted to the controller 40.

The BMS 21 receives a charge or discharge request from the controller 40, and, in response to the received request, controls the switch 50 to selectively use the battery 20 or the supercapacitor 30, thereby transmitting a discharge power to an inverter 11 or transmitting regenerative braking power generated by the drive motor 10 to the battery 20 or the supercapacitor 30 for charging.

The BMS 21 may include sensors that sense a voltage, current, and temperature of the battery 20 and/or the supercapacitor 30 and may further include at least one processor that executes commands for a predetermined process for determining a state of charge or a state of health of the battery 20 or the supercapacitor 30, or for cell-balancing the battery 20, or preventing the battery 20 or the supercapacitor 30 from being over-charged or over-discharged based on information of the sensors and a memory for storing the commands.

Also, the BMS 21 may transmit information sensed by the sensors to the controller 40, and the controller 40 may execute a control process based on the received information.

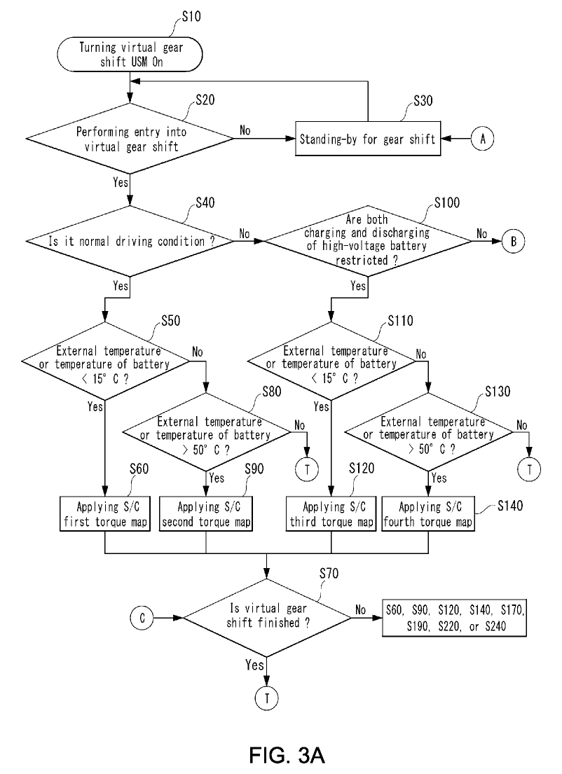

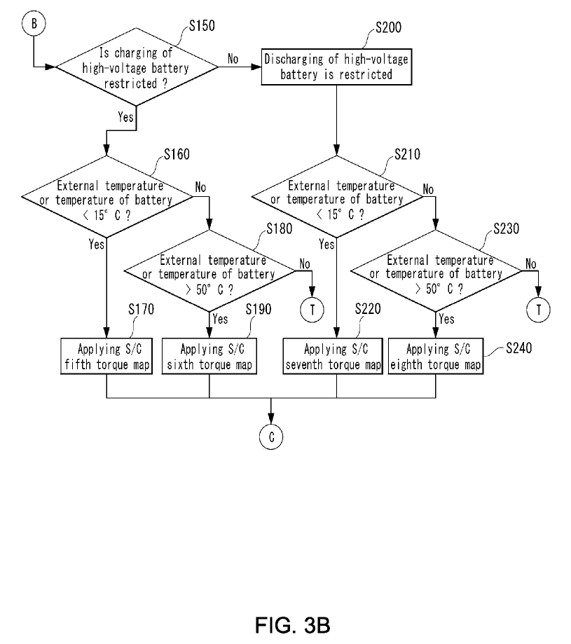

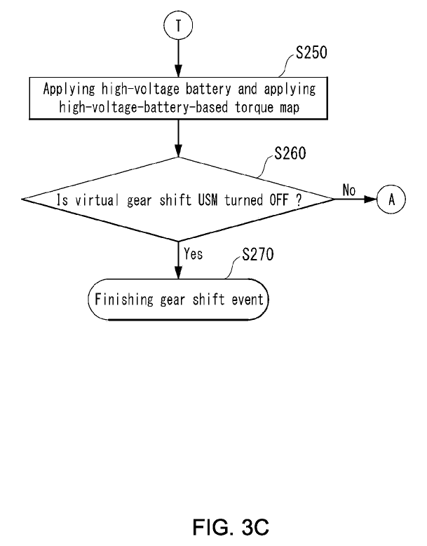

FIGS. 3A, 3B, and 3C are flowcharts representing example embodiments of the control process performed by the controller 40, which will be described herein.

First, in a process S10, as a driver selects a virtual gear shift mode through a user settings menu, the controller 40 confirms the selection. For example, the user settings menu may be displayed through an audio video navigation (AVN) screen, and a selection of a menu may be recognized through a touch of the driver on the screen and transmitted to the controller 40.

In a process S20, the controller 40 may determine whether entry into the virtual gear shift control is performed based on a predetermined condition.

The virtual gear shift control may be executed using a torque map based on the battery 20. For example, the virtual gear shift control using a torque map may be implemented as provided in U.S. Patent No. US11872890.

In the process S20, when it is determined that the entry into the virtual gear shift control is not performed (No in the process S20), it may be (e.g., continuously) determined whether a condition for the entry into the virtual gear shift control is satisfied through the process S20 while standing by in a process S30.

When the entry into the virtual gear shift control is performed (Yes in the process S20), the controller 40 determines in the process S40 whether the vehicle 100 is in a normal driving condition that the battery 20 can be charged and discharged. In the process S40, the controller 40 may determine whether charging and discharging of the battery 20 is in a normal state where the charging and discharging is possible. When the battery 20 is determined to be in the normal state, the controller 40 may determine, in a process S50, whether an external temperature or a temperature of the battery 20 is less than a first preset temperature.

Here, the temperature of the battery 20 may represent a lowest temperature of the temperatures of battery cells of the battery 20.

Also, although the first preset temperature is 15°C in an example embodiment, the present disclosure is not limited to the example embodiment.

When it is determined in the process S50 that the temperature is less than the first preset temperature, the controller 40 performs the virtual gear shift control by using a first torque map of the supercapacitor 30 in a process S60.

When it is determined in the process S50 that the temperature is not less than the first preset temperature, the controller 40 determines whether the temperature is greater than a second preset temperature in a process S80. Here, although the second preset temperature is 50°C, the embodiment of the present disclosure is not limited thereto.

When it is determined in a process S80 that the temperature is greater than the second preset temperature, the controller 40 performs the virtual gear shift control by using the first torque map of the supercapacitor 30 in a process S90.

Here, when it is determined in the process S80 that the temperature is not greater than the second preset temperature, i.e., when the temperature is between the first and second preset temperatures, a process S250 of FIG. 3C (described herein) will be performed.

Also, in the process S40, when it is determined that the charging and discharging of the battery 20 are not in the normal state, the controller 40 determines, in a process S100, whether the charging and discharging of the battery 20 are both restricted.

When it is determined in the process S100 that both the charging and discharging of the battery 20 are restricted, the controller 40 determines, in a process S110, whether the temperature is less than the first preset temperature.

When it is determined in the process S110 that the temperature is less than the first preset temperature, the controller 40 performs the virtual gear shift control by using a third torque map of the supercapacitor 30 in a process S120.

When it is determined in the process S110 that the temperature is not less than the first preset temperature, the controller 40 determines, in a process S130, whether the temperature is greater than the second preset temperature.

When it is determined in the process S130 that the temperature is greater than the second preset temperature, the controller 40 performs the virtual gear shift control by using a fourth torque map of the supercapacitor 30 in a process S140.

Here, when it is determined in the process S130 that the temperature is not greater than the second preset temperature, i.e., when the temperature is between the first and second preset temperatures, a process S250 is performed.

When it is determined in the process S100 that one of the charging and discharging of the battery 20 is restricted (No in the process S100), the controller 40 determines, in a process S150 of FIG. 3B, whether the charging of the battery 20 is restricted.

When it is determined in the process S150 that the charging of the battery 20 is restricted, the controller 40 determines, in a process S160, whether the temperature is less than the first preset temperature.

When it is determined in the process S160 that the temperature is less than the first preset temperature, the controller 40 performs the virtual gear shift control by using a fifth torque map of the supercapacitor 30 in a process S170.

When it is determined in the process S160 that the temperature is not less than the first preset temperature, the controller 40 determines, in a process S180, whether the temperature is greater than the second preset temperature.

Also, when it is determined in the process S180 that the temperature is greater than the second preset temperature, the controller 40 performs the virtual gear shift control by using a sixth torque map of the supercapacitor 30 in a process S190.

Here, when it is determined in the process S180 that the temperature is not greater than the second preset temperature, i.e., when the temperature is between the first and second preset temperatures, the process S250 is performed.

On the other hand, when it is determined in the process S150 that the charging of the battery 20 is not restricted (No in the process S150), the controller 40 determines, in a process S200, that the discharging of the battery 20 is restricted.

Also, the controller 40 determines, in a process S210, whether the temperature is less than the first preset temperature.

When it is determined in the process S210 that the temperature is less than the first preset temperature, the controller 40 performs the virtual gear shift control by using a seventh torque map of the supercapacitor 30 in a process S220.

When it is determined in the process S210 that the temperature is not less than the first preset temperature, the controller 40 determines, in a process S230, whether the temperature is greater than the second preset temperature.

When it is determined in the process S230 that the temperature is greater than the second preset temperature, the controller 40 performs the virtual gear shift control by using an eighth torque map of the supercapacitor 30 in a process S240.

Here, when it is determined in the process S230 that the temperature is not greater than the second preset temperature, i.e., when the temperature is between the first and second preset temperatures, the process S250 is performed.

After the processes S60, S90, S120, S140, S170, S190, S220, and S240 of FIGS. 3A and 3B are performed, a process S70 of FIG. 3A is performed. In the process S70, the controller 40 determines whether the virtual gear shift control is finished.

When it is determined in the process S70 that the virtual gear shift control is finished, the controller 40 performs the process S250. When it is determined in the process S70 that the virtual gear shift control is not finished, the controller 40 (e.g., continuously) performs the processes S60, S90, S120, S140, S170, S190, S220, or S240 to finish the virtual gear shift control.

In the process S250, the controller 40 performs the virtual gear shift control using the battery 20 instead of the supercapacitor 30. Here, a ninth torque map, which may be determined based on the battery 20, may be used. The process S250 may be performed in a similar way to the way the control process is performed in U.S. Patent No. US11872890.

On the other hand, when a driver releases the virtual gear shift mode through the user settings menu (USM), i.e., when the driver turns the virtual gear shift mode USM off (Yes of a process S260), the controller 40 finishes the virtual gear shift mode in a process S270. Here, when the virtual gear shift mode is not released, the controller 40 stands by in the process S30 until a condition for the virtual gear shift control is satisfied.

Hereinafter, the above-described first to eighth torque maps that are charge and discharge torque maps for the supercapacitor 30 will be described.

First, the first torque map may be experimentally obtained through a test for a vehicle in consideration of a driving performance in a condition of the process S60, i.e., when the charging and discharging of the battery 20 are normally performed, and the temperature is less than the first preset temperature.

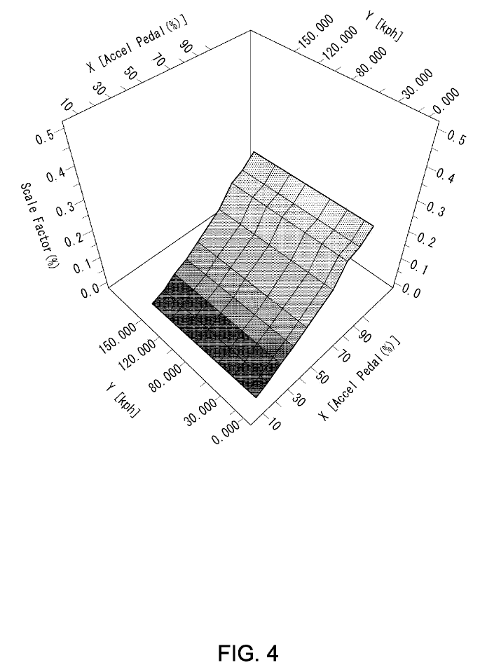

FIG. 4 is a view illustrating an example of a torque map that is experimentally obtained through a test. As illustrated in FIG. 4, the torque map may be a three-axis map based on values of an accelerator position sensor (APS), a speed of a vehicle, and a scaling factor. For example, data for APS values, speeds of the vehicle, and scaling factors can be experimentally obtained through a test for the vehicle, and the torque map shown in FIG. 4 can be obtained based on the data.

Here, the scaling factor may be a calculation factor of a driver request torque. For example, the request torque may be determined through a multiplication of the scaling factor and a wheel torque.

Thus, the first torque map may be secured by obtaining a torque map like the one of FIG. 4 through an experimental test in the condition of the process S60. Here, a plurality of torque maps may be obtained according to temperatures, and a torque map at an intermediate temperature may be determined by interpolation.

Similarly, the second torque map may be experimentally obtained by obtaining a torque map like the one of FIG. 4 through an experimental test in consideration of a driving performance in a condition of the process S90, i.e., when the charging and discharging of the battery 20 are normally performed, and the temperature is greater than the second preset temperature.

Also, the third torque map may be experimentally obtained by obtaining a torque map like the one of FIG. 4 through an experimental test in consideration of a driving performance in a condition of the process S120, i.e., when both the charging and discharging of the battery 20 are restricted, and the temperature is less than the first preset temperature.

Also, the fourth torque map may be experimentally obtained by obtaining a torque map like the one of FIG. 4 through an experimental test in consideration of a driving performance in a condition of the process S140, i.e., when the battery 20 is normally charged and discharged, and the temperature is greater than the second preset temperature.

Also, the fifth torque map may be experimentally obtained by obtaining a torque map like the one of FIG. 4 through an experimental test in consideration of a driving performance in a condition of the process S170, i.e., when the discharging of the battery 20 is allowed while the charging of the battery 20 is restricted, and the temperature is less than the first preset temperature.

Also, the sixth torque map may be experimentally obtained by obtaining a torque map like the one of FIG. 4 through an experimental test in consideration of a driving performance in a condition of the process S190, i.e., when the discharging of the battery 20 is allowed while the charging of the battery 20 is restricted, and the temperature is greater than the second preset temperature.

Also, the seventh torque map may be experimentally obtained by obtaining a torque map like the one of FIG. 4 through an experimental test in consideration of a driving performance in a condition of the process S220, i.e., when the charging of the battery 20 is allowed while the discharging of the battery 20 is restricted, and the temperature is less than the first preset temperature.

Also, the eighth torque map may be experimentally obtained by obtaining a torque map like the one of FIG. 4 through an experimental test in consideration of a driving performance in a condition of the process S240, i.e., when the charging of the battery 20 is allowed while the discharging of the battery 20 is restricted, and the temperature is greater than the second preset temperature.

When the request torque is determined by using the above-described torque maps, power for outputting the request torque is determined, and the controller 40 performs virtual gear shift control while controlling the supercapacitor 30 to discharge or charge the corresponding power.

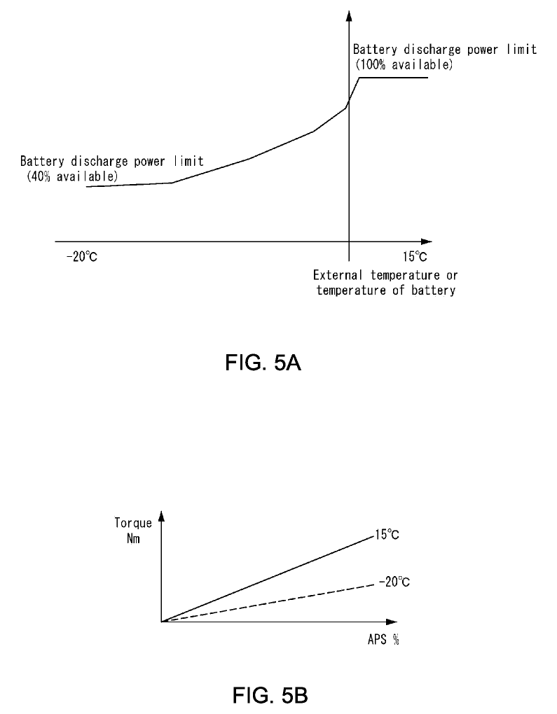

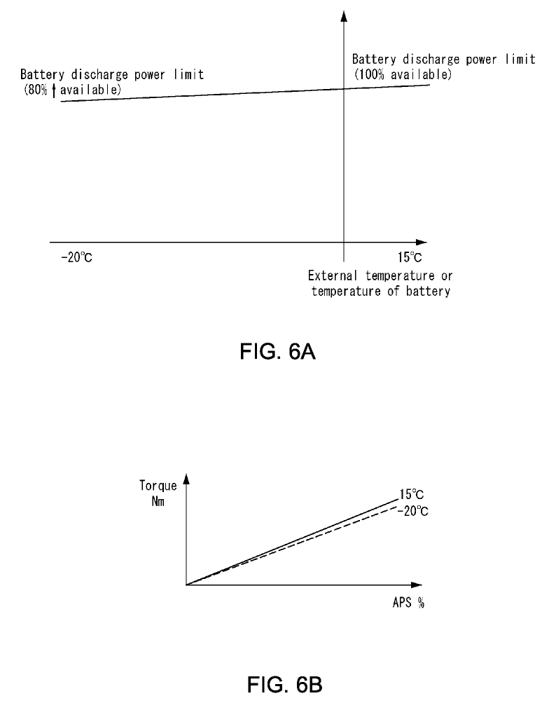

FIG. 5A illustrates a graph showing discharge characteristics of the battery 20 according to an external temperature or a temperature of the battery 20 and FIG. 5B illustrates an APS-torque graph at a vehicle speed of 20 kph, and FIG. 6A illustrates a graph showing discharge characteristics of the supercapacitor 30 according to an external temperature or a temperature of the supercapacitor 30 and FIG. 6B illustrates an APS–torque graph at a vehicle speed of 20 kph.

As shown in FIG. 5A, FIG. 5B, FIG. 6A and FIG. 6B, in a low-temperature condition, when discharge power of the battery 20 is (e.g., significantly) restricted, an output torque thereof may be reduced. On the other hand, when discharge power of the supercapacitor 30 is not (e.g., significantly) restricted, an output torque thereof may not be (e.g., significantly) reduced.

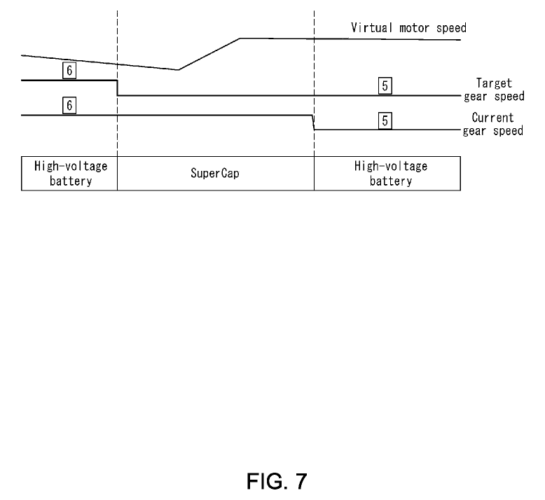

Also, FIG. 7 illustrates an example of execution of the virtual gear shift according to an example embodiment of the present disclosure. In a condition in which the temperature is less than the first preset temperature or greater than the second preset temperature, when it is determined that a target gear is a five-speed as a virtual gear shift control condition is satisfied while driving at a six-speed by using the battery 20, the controller 40 performs the virtual gear shift control by using the supercapacitor 30, so that the vehicle may drive in a five-speed virtual gear shift state.

Here, when the supercapacitor 30 is not provided, the virtual gear shift control may not be executed by using only the battery 20. Thus, the vehicle continues to drive in the six-speed virtual gear shift state.

According to an example embodiment of the present disclosure, the virtual gear shift may be implemented even when the charging or the discharging of the battery is restricted or even in the specific temperature condition.

Also, according to an example embodiment of the present disclosure, the energy efficiency may be improved, and the durability of the battery and the fuel efficiency may be improved by dualizing the power supply source for the drive motor using the battery and the supercapacitor.

What is claimed is:

1. A vehicle comprising:
a drive motor;
a battery configured to discharge a first power to supply to the drive motor or to be charged by a second power generated by regenerative braking of the drive motor;
a supercapacitor configured to discharge a third power to supply to the drive motor or to be charged by the second power; and
a controller including a memory storing computer-readable instructions and at least one processor configured to execute the computer-readable instructions,
wherein the computer-readable instructions comprise:
operating the vehicle in a virtual gear shift mode using the supercapacitor based on a torque map determined by a chargeable or dischargeable state of the battery or a temperature of the battery or an external temperature around the vehicle.

2. The vehicle of claim 1, wherein the virtual gear shift mode is based on a first torque map or a second torque map determined based on the temperature when the battery is in a chargeable and dischargeable state.

3. The vehicle of claim 2, wherein the virtual gear shift mode is based on the first torque map when the temperature is lower than a first preset temperature, and the virtual gear shift mode is based on the second torque map when the temperature is greater than a second preset temperature.

4. The vehicle of claim 1, wherein the virtual gear shift mode is based on a third torque map or a fourth torque map determined based on the temperature when both charging and discharging of the battery are restricted.

5. The vehicle of claim 4, wherein the virtual gear shift mode is based on the third torque map when the temperature is lower than a first preset temperature, and the virtual gear shift mode is based on the fourth torque map when the temperature is greater than a second preset temperature.

6. The vehicle of claim 1, wherein the virtual gear shift mode is based on a fifth torque map or a sixth torque map determined based on the temperature when charging of the battery is restricted.

7. The vehicle of claim 6, wherein the virtual gear shift mode is based on the fifth torque map when the temperature is lower than a first preset temperature, and the virtual gear shift mode is based on the sixth torque map when the temperature is greater than a second preset temperature.

8. The vehicle of claim 1, wherein the virtual gear shift mode is based on a seventh torque map or an eighth torque map determined based on the temperature when discharging of the battery is restricted.

9. The vehicle of claim 8, wherein the virtual gear shift mode is based on the seventh torque map when the temperature is lower than a first preset temperature, and the virtual gear shift mode is based on the eighth torque map when the temperature is greater than a second preset temperature.

10. The vehicle of claim 1, wherein the virtual gear shift mode is based on a ninth torque map when the temperature is greater than or equal to a first preset temperature and less than or equal to a second preset temperature.

11. A method for controlling a vehicle comprising a drive motor, a battery configured to discharge a first power to supply to the drive motor or to be charged by second power generated by regenerative braking of the drive motor, a supercapacitor configured to discharge third power to supply to the drive motor or to be charged by the second power, and a controller including a memory storing computer-readable instructions and at least one processor configured to execute the computer-readable instructions, the method comprising:
determining, by the controller, a chargeable state or a dischargeable state of the battery; and
performing, by the controller, a virtual gear shift mode of the vehicle using the supercapacitor based on a torque map which is determined based on a temperature of the battery or an external temperature around the vehicle.

12. The method of claim 11, wherein the performing of the virtual gear shift mode comprises performing the virtual gear shift mode based on a first torque map or a second torque map determined based on the temperature when the battery is in a chargeable and dischargeable state.

13. The method of claim 12, wherein the performing of the virtual gear shift mode based on the first torque map or the second torque map comprises:
performing the virtual gear shift mode based on the first torque map when the temperature is lower than a first preset temperature; and
performing the virtual gear shift mode based on the second torque map when the temperature is greater than a second preset temperature.

14. The method of claim 11, wherein the performing of the virtual gear shift mode comprises performing the virtual gear shift mode based on a third torque map or a fourth torque map based on the temperature when both charging and discharging of the battery are restricted.

15. The method of claim 14, wherein the performing of the virtual gear shift mode based on the third torque map or the fourth torque map comprises:
performing the virtual gear shift mode based on the third torque map when the temperature is lower than a first preset temperature; and
performing the virtual gear shift mode based on the fourth torque map when the temperature is greater than a second preset temperature.

16. The method of claim 11, wherein the performing of the virtual gear shift mode comprises performing the virtual gear shift mode based on a fifth torque map or a sixth torque map based on the temperature when charging of the battery is restricted.

17. The method of claim 16, wherein the performing of the virtual gear shift mode based on the fifth torque map or the sixth torque map comprises:
performing the virtual gear shift mode based on the fifth torque map when the temperature is lower than a first preset temperature; and
performing the virtual gear shift mode based on the sixth torque map when the temperature is greater than a second preset temperature.

18. The method of claim 11, wherein the performing of the virtual gear shift mode comprises performing the virtual gear shift mode based on a seventh torque map or an eighth torque map based on the temperature when discharging of the battery is restricted.

19. The method of claim 18, wherein the performing of the virtual gear shift mode based on the seventh torque map or the eighth torque map comprises:
performing the virtual gear shift mode based on the seventh torque map when the temperature is lower than a first preset temperature; and
performing the virtual gear shift mode based on the eighth torque map when the temperature is greater than a second preset temperature.

20. The method of claim 11, wherein the performing of the virtual gear shift mode comprises performing the virtual gear shift mode using the battery according to a ninth torque map when the temperature is greater than or equal to a first preset temperature and lower than or equal to a second preset temperature.
